(19) United States
(12) Patent Application Publication
(10) Pub. No.: US 2026/0247394 A1
(43) Pub. Date: Aug. 20, 2026

(54) APPARATUSES AND METHODS FOR FACILITATING A SERVICE-AWARE SCHEDULER FOR TERMINALS INCLUDED AS PART OF COMMUNICATION NETWORKS AND SYSTEMS

(71) Applicants: AT&T Intellectual Property I, L.P., Atlanta, GA (US); AT&T Technical Services Company, Inc., Vienna, VA (US)

(72) Inventors: Daniel Vivanco, Ashburn, VA (US); Yupeng Jia, South Pasadena, CA (US)

(73) Assignees: AT&T Intellectual Property I, L.P., Atlanta, GA (US); AT&T Technical Services Company, Inc., Vienna, VA (US)

(21) Appl. No.: 19/056,840

(22) Filed: Feb. 19, 2025

(51) Int. Cl. H04W 72/231; H04W 72/0446; H04W 72/12; H04W 72/566; H04W 84/06

(52) U.S. Cl. CPC H04W 72/231; H04W 72/0446; H04W 72/12; H04W 72/566; H04W 84/06

(57) ABSTRACT

Aspects of the subject disclosure may include, for example, obtaining first data and second data, wherein the first data is classified as having a first priority value and the second data is classified as having a second priority value that is different from the first priority value, scheduling a transfer of the first data to a terminal in accordance with the first priority value such that the transfer of the first data occurs during a first timeslot included in a plurality of timeslots, and scheduling a transfer of the second data to the terminal in accordance with the second priority value such that the transfer of the second data occurs during a second timeslot included in the plurality of timeslots. Other embodiments are disclosed.

### FIELD OF THE DISCLOSURE

The subject disclosure relates to apparatuses and methods for facilitating a service-aware scheduler for terminals included as part of communication networks and systems.

### BACKGROUND

In recent years, the deployment of various types of terminals, such as unmanned aerial vehicles (UAVs), has expanded significantly across various industries, including delivery services, infrastructure inspection, and emergency response. These and other applications often require reliable, beyond visual line-of-sight communications, which are facilitated by mobile networks/systems offering wide-area, high-speed, and secure wireless connectivity. However, existing technologies, primarily designed for terrestrial use, face challenges in efficiently supporting UAV operations. The need for enhanced connectivity solutions is underscored by the importance of command and control (C2) communications, which are necessary for the safe navigation and operation of UAVs.

Current network/system configurations face challenges in balancing the stringent quality of service (QoS) requirements for C2 traffic with the power-saving needs of UAVs. The inability to effectively manage these dual demands can lead to increased power consumption and potential communication delays, which are detrimental to UAV performance and safety.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a diagram illustrating an example, non-limiting embodiment of a system in accordance with various aspects described herein.

FIG. 2B is a diagram depicting a relationship between signaling and time in accordance with aspects of this disclosure.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for facilitating a transfer of data involving a terminal based on considerations pertaining to performance and resource conservation/preservation. Other embodiments are described in the subject disclosure.

One or more aspects of the subject disclosure include, in whole or in part, obtaining first data and second data, wherein the first data is classified as having a first priority value and the second data is classified as having a second priority value that is different from the first priority value; scheduling a transfer of the first data to a terminal in accordance with the first priority value such that the transfer of the first data occurs during a first timeslot included in a plurality of timeslots; and scheduling a transfer of the second data to the terminal in accordance with the second priority value such that the transfer of the second data occurs during a second timeslot included in the plurality of timeslots.

One or more aspects of the subject disclosure include, in whole or in part, obtaining first data associated with a first drone, the first data including first control data that controls a first maneuver of the first drone; obtaining second data associated with the first drone, the second data including first payload data associated with a first application executed by the first drone; scheduling a transfer of the first data and the second data to the first drone based on a first priority level associated with the first control data and a second priority level associated with the first payload data, wherein the scheduling provides that the first drone enters a first power-saving mode of operation upon a completion of the transfer of the first data and the second data to the first drone; and transferring the first data and the second data to the first drone based on the scheduling of the transfer of the first data and the second data to the first drone.

One or more aspects of the subject disclosure include, in whole or in part, transmitting, by a processing system including a processor, a downlink control information (DCI) element to a terminal during a first timeslot, wherein the DCI element includes a value of an offset parameter corresponding to a difference in timeslots from the first timeslot to a second timeslot that is subsequent to the first timeslot; transmitting, by the processing system and based on the transmitting of the DCI element to the terminal, control data to the terminal during the second timeslot, the control data controlling an operation of the terminal; and transmitting, by the processing system and based on the transmitting of the DCI element to the terminal, payload data to the terminal during one of the second timeslot or a third timeslot.

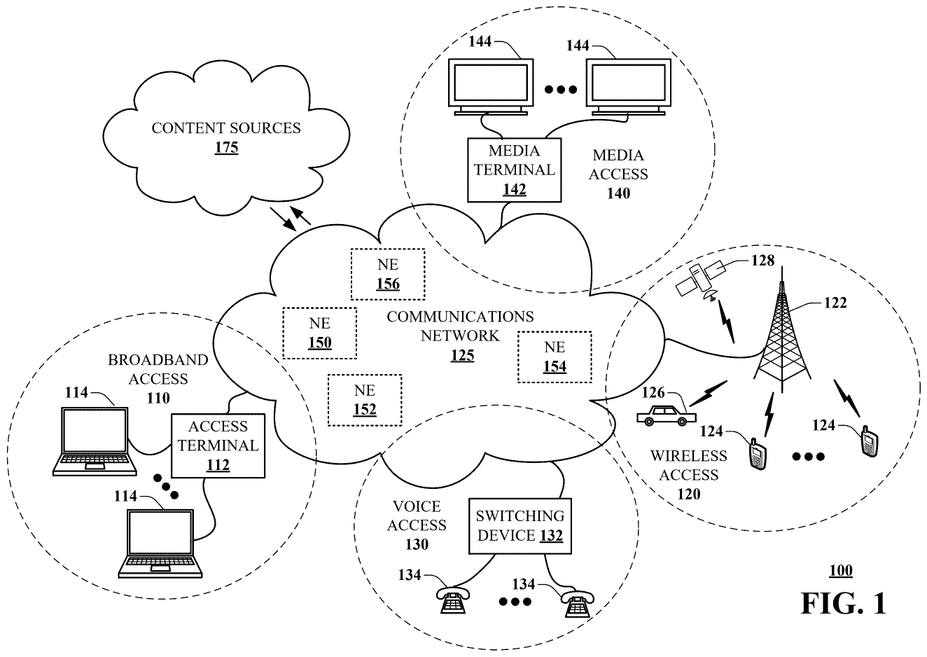

Referring now to FIG. 1, a block diagram is shown illustrating an example, non-limiting embodiment of a system 100 in accordance with various aspects described herein. For example, the system 100 can facilitate, in whole or in part, obtaining first data and second data, wherein the first data is classified as having a first priority value and the second data is classified as having a second priority value that is different from the first priority value, scheduling a transfer of the first data to a terminal in accordance with the first priority value such that the transfer of the first data occurs during a first timeslot included in a plurality of timeslots, and scheduling a transfer of the second data to the terminal in accordance with the second priority value such that the transfer of the second data occurs during a second timeslot included in the plurality of timeslots. The system 100 can facilitate, in whole or in part, obtaining first data associated with a first drone, the first data including first control data that controls a first maneuver of the first drone, obtaining second data associated with the first drone, the second data including first payload data associated with a first application executed by the first drone, scheduling a transfer of the first data and the second data to the first drone based on a first priority level associated with the first control data and a second priority level associated with the first payload data, wherein the scheduling provides that the first drone enters a first power-saving mode of operation upon a completion of the transfer of the first data and the second data to the first drone, and transferring the first data and the second data to the first drone based on the scheduling of the transfer of the first data and the second data to the first drone. The system 100 can facilitate, in whole or in part, transmitting, by a processing system including a processor, a downlink control information (DCI) element to a terminal during a first timeslot, wherein the DCI element includes a value of an offset parameter corresponding to a difference in timeslots from the first timeslot to a second timeslot that is subsequent to the first timeslot, transmitting, by the processing system and based on the transmitting of the DCI element to the terminal, control data to the terminal during the second timeslot, the control data controlling an operation of the terminal, and transmitting, by the processing system and based on the transmitting of the DCI element to the terminal, payload data to the terminal during one of the second timeslot or a third timeslot.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122 (and/or via satellite 128), voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices. In various embodiments, the satellite 128 can be configured for bi-directional communication with one or more access points, with one or more base stations, and/or with one or more mobile devices (e.g., direct-to-cell). In various embodiments, the satellite 128 can comprise a Low Earth Orbit (LEO) satellite or a Geostationary Orbit (GEO) satellite.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

By way of introduction, aspects of this disclosure may be utilized to provide a service-aware dual cross-slot scheduling mechanism that may be designed and operated for aerial drones, unmanned aerial vehicles (UAVs), connected cars, and the like (or more generally, one or more terminals). This innovative approach may enhance (e.g., optimize) power savings for terminals, while ensuring that quality of service (QoS), quality of experience (QoE), and/or key performance indicator (KPI) requirements are met. The development introduces a centralized self-learning network/system configuration that can be applied in a cascade mode to a cluster of drones, enhancing power efficiency across multiple devices. Additionally, aspects of this disclosure include (proposed) modifications to Third Generation Partnership Project (3GPP) specifications to incorporate new Information Elements (IEs) in a cross-slot scheduling object for multi-mode (e.g., dual-mode) traffic, signaling, communications, and the like. Aspects of this disclosure enable a differentiated handling of command and control (C2) traffic, which may be important for navigation and safety, and payload data, which typically is more tolerant to latency/delay. By assigning and utilizing multiple parametric values (referred to herein at various points as k0 values), aspects of this disclosure may prioritize C2 traffic with reduced (e.g., minimal) delay while allowing other data (e.g., payload data) to be scheduled in clusters, thus enhancing (e.g., maximizing) micro-sleep opportunities for the terminals and significantly reducing power consumption. This approach not only enhances individual user experience by customizing scheduling mechanisms for battery-constrained terminals but also positions the development as a significant differentiator among (wireless) network/system operators and service providers.

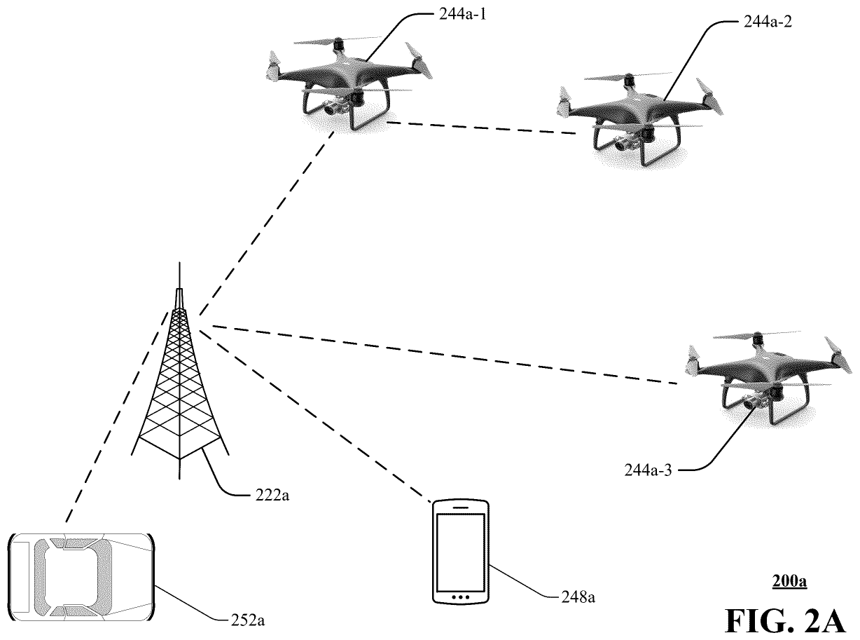

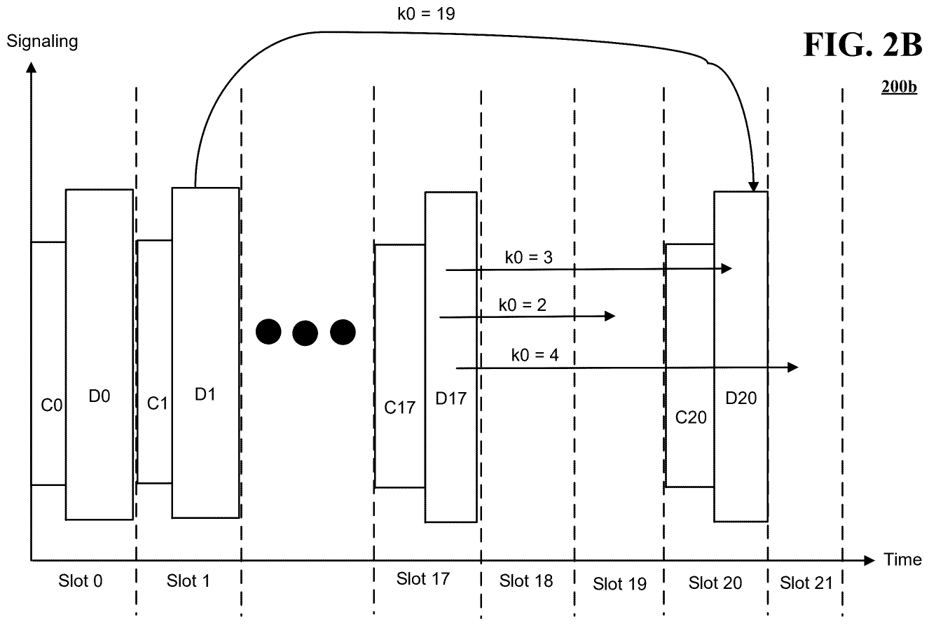

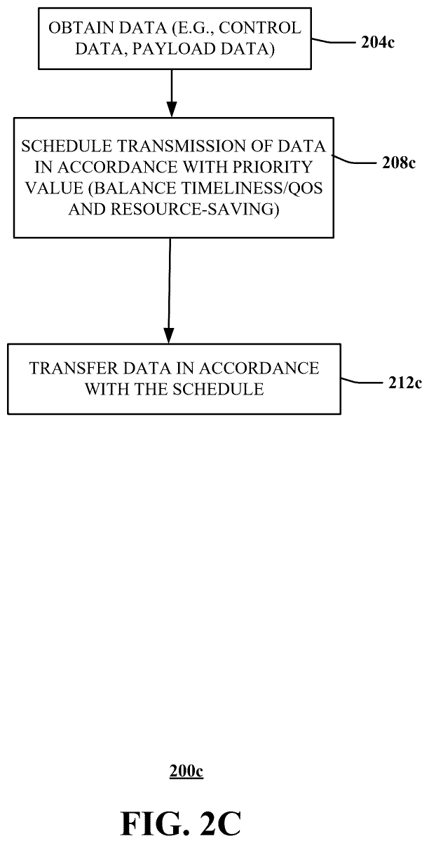

With the foregoing in mind, reference may now be made to FIG. 2A, which is a diagram illustrating an example, non-limiting embodiment of a system 200a in accordance with various aspects described herein. In some embodiments, one or more parts/portions of the system 200a may be combined with, or operatively overlaid upon, one or more parts/portions of the system 100 of FIG. 1.

The system 200a may include a number of entities, such as for example a tower or base station 222a, a first terminal 244a-1 (e.g., a first drone), a second terminal 244a-2 (e.g., a second drone), a third terminal 244a-3 (e.g., a third drone), a fourth terminal 248a (e.g., a smartphone), and a fifth terminal 252a (e.g., a connected car). The number (5) of terminals shown in FIG. 2A is illustrative, which is to say that more or fewer terminals may be included/utilized in a given embodiment. Further, the type (e.g., drone, smartphone, connected car, etc.) of each terminal is exemplary, which is to say that a different type of terminal may be utilized in a given embodiment.

The base station 222a may facilitate communication with various ones of the terminals, as part of one or more network or system operations. The base station 222a may play a crucial role in managing communication links and scheduling mechanisms described herein, particularly in the context of service-aware scheduling for aerial drones.

As shown in FIG. 2A, the first terminal 244a-1 and the second terminal 244a-2 may be arranged in a cascade relationship/configuration by virtue of the link/channel between them. Aspects of the cascade arrangement may be used to effectively expand the scope and reach of the base station 222a relative to, e.g., the second terminal 244a-2. It may be the case that configuration information, such as k0 configuration information for cross-slot scheduling, can be exchanged directly between terminals (e.g., the first terminal 244a-1 and the second terminal 244a-2), rather than solely relying on network/system infrastructure (e.g., the base station 222a). This cascade arrangement involving the first terminal 244a-1 and the second terminal 244a-2 may allow, e.g., the first terminal 244a-1 to pass/provide configuration data to another terminal, like the second terminal 244a-2, thereby enhancing power efficiency and reducing network/system signaling load. This cascade relationship may facilitate a more efficient and autonomous operation of the terminals, contributing to the overall power-saving goals of aspects of this disclosure. In the cascade arrangement shown in FIG. 2A, the first terminal 244a-1 may serve as a primary node/terminal and the second terminal 244a-2 may serve as a secondary node/terminal. Of course, the roles could be reversed without departing from the scope and spirit of this disclosure. Moreover, based on dynamic characteristics or considerations (such as, for example, based on a position of a terminal relative to the base station and/or other terminals), the role of primary and secondary may change. It is noted that even in a cascade arrangement, any and all terminals involved in the cascade arrangement may be able to directly engage in data transfer operations with respect to a base station 222a. For example, it may be the case that the use of the cascade arrangement may help to facilitate a transfer of control information to or from a terminal that is at least “one hop” removed from the base station (as is the case shown in respect of the second terminal 244a-2 in FIG. 2A being one hop removed from the base station 222a by virtue of the first terminal 244a-1 disposed therebetween).

By virtue of the arrangement shown in FIG. 2A, a terminal (e.g., a UAV) may use, e.g., LTE/5G radio technologies to communicate with the base station 222a. A command and control (C2) link may be used to communicate between the base station 222a and the terminal (in the downlink direction and/or in the uplink direction). The C2 link may be responsible/utilized for the management and control of the terminal. For example, the C2 link of a UAV may allow an operator of the UAV to operate on, and control, the trajectory of the UAV and understand the state of the UAV. In some embodiments, the C2 link may be used to control a maneuver of the UAV/drone, such as managing a change in terms of: a direction of travel, an altitude, a speed, an acceleration, etc.). In general, the C2 link may be used to control the UAV, and to receive health and status information of the UAV. In addition, the UAV may share/utilize a payload-data link with the base station 222a, which may be used to pass non-critical data (e.g., maps, videos, pictures, text documents, emails, etc.) between the UAV and the base station 222a. In some embodiments, the C2 link and/or the payload-data link may be configured as physical channels or mediums. In other embodiments, the C2 link and the payload-data link may utilize a common physical channel or medium but may be distinguished from one another on a logical basis.

In some embodiments, traffic/data associated with the C2 link may be given a higher priority relative to traffic/data associated with the payload-data link. For example, packet loss or delay potentially exceeding one or more thresholds may compromise an ability for a UAV (or more generally, terminal) to be operated safely and reliably. In some embodiments, metadata, fields of a header (e.g., differentiated service code point [DSCP] fields), or the like, may be used to differentiate/distinguish different types of traffic from one another (e.g., to distinguish C2 traffic from payload-data traffic).

In various embodiments, the base station 222a (or more generally, network/system infrastructure, such as central node of a core network, a mobile edge computing (MEC) device, a self-organizing network (SON) node, a radio intelligent controller (RIC), etc.) may generate and maintain a schedule pertaining to signaling/communications involving one or more of the terminals 244a-1, 244a-2, 244a-3, 248a, and 252a. In general, the schedule may adhere to aspects of cross-slot scheduling, which is a terminal power saving technique that was introduced as part of Release 16 in conjunction with the 3GPP for 5G technology. Cross-slot scheduling may be applied to a terminal (or user equipment) when the terminal is in an RRC-Connected mode of operation. Cross-slot scheduling may allow the terminal to perform/operate in micro sleep cycles and reduce Physical Downlink Control Channel (PDCCH) processing, which may result in a reduction in power consumption of the terminal.

Conventionally, when a terminal is in a RRC-Connected mode, the terminal must continuously monitor all the downlink slots of a subframe to check for incoming data. This procedure involves the terminal decoding the PDCCH in each slot to check for a grant notification that indicates that data will be scheduled to the terminal in a consecutive Physical Downlink Shared Channel (PDSCH). As one of skill in the art will appreciate, the PDCCH is the channel that carries Downlink Control Information (DCI), which has several functionalities in relation to this disclosure, such as carrying the information to allocate physical resources for PDSCH.

Based on the PDCCH-DCI format, the terminal may derive the value of k0 referenced above. In general, k0 may correspond to an offset (in terms of, e.g., slot numbers or counts) between a first slot corresponding to receipt of the DCI by the terminal and a second slot corresponding to the physical resources assigned to the terminal for receiving/obtaining data in conjunction with PDSCH. At least in theory, k0 can be range between zero (meaning that DCI and PDSCH occur within the same slot—a special case that may be referred to herein as same slot scheduling) and infinity, but practically speaking a range from zero to thirty-two is representative of the value that k0 may assume in most applications.

When a terminal is scheduled to receive PDSCH (which may correspond to or include C2 traffic or payload-data traffic as described above) by a PDCCH-DCI grant, a time domain resource assignment field of the PDCCH-DCI grant may provide a (row) index of a table (referred to herein as pdsch-symbolAllocation), where the indexed row may define the slot offset k0, a starting symbol(S), and an allocation length (L). The base station 222a may configure the time domain resource assignment field in PDCCH-DCI, which may then be sent to a terminal (e.g., the first terminal 244a-1) via a SIB1 message or dedicated RRC signaling, for example.

Once a terminal is configured with the time domain resource assignment by the base station 222a, the terminal may monitor PDCCH-DCI and decode the pdsch-symbolAllocation to check for a data grant indicator and corresponding k0, S, and L parameters. If k0 is absent in/from the pdsch-symbolAllocation, the terminal may assume that some or all of the PDSCH allocations will occur in the same slot where the PDCCH-DCI is allocated (e.g., the terminal may assume that k0=0 in the absence of a specification of k0).

If cross-slot scheduling is not used/configured, a terminal may decode PDCCH in every timeslot and buffer the corresponding PDSCH data/traffic of the timeslot when the terminal is in the RRC-Connected mode, even if no data has actually been scheduled for the terminal as part of the timeslot. This condition may be considered as being inefficient, because the terminal is expending resources and energy buffering PDSCH data/traffic that is not even intended for the terminal.

Thus, as one of skill in the art will appreciate, aspects of this disclosure, inclusive of aspects pertaining to the use of k0, may enable a terminal to enter a power saving mode or sleep mode by effectively and intelligently scheduling when traffic/data (e.g., C2 traffic or payload-data traffic) is provided to the terminal (or, analogously, when traffic/data is obtained from the terminal). For example, aspects of the use of k0 may serve to cluster or combine data into one or more timeslots (or consecutive timeslots). During those timeslots where the terminal is not scheduled to engage in a data transaction/transfer operation, the terminal may enter a micro-sleep mode coinciding with the PDSCH portion of the timeslot. In this regard, it is noted that the terminal may still need to monitor PDCCH of timeslots during which the terminal is not scheduled to engage in a (PDSCH) data transfer, in the event that other DCI-grants are delivered during such timeslots.

To demonstrate aspects of the foregoing by way of example, reference may now be made to FIG. 2B, which is a timing diagram 200b depicting a subdivision of time along the horizontal axis into one or more slots (illustratively denoted and distinguished from one another as slot 0, slot 1, ...slot 17, slot 18, slot 19, slot 20, slot 21, . . . and so on), and signaling/communications along the vertical axis. In each slot there may be a control portion or control channel (which may incorporate aspects of PDCCH and/or DCI as described above) and a data portion or data channel (which may incorporate aspects of C2 traffic or payload-data traffic as described above, potentially in conjunction with aspects of PDSCH as described above). Furthermore, in the symbology of FIG. 2B, the control channel associated with slot zero is denoted as C0, the data channel associated with slot zero is denoted as D0, the control channel associated with slot one is denoted as C1, the data channel associated with slot one is denoted as D1, and so on (inclusive of C17 and D17 for slot 17 and C20 and D20 for slot 20 as shown). It may be assumed for this disclosure that FIG. 2B pertains to the scheduling mechanism described above for a given terminal (e.g., the first terminal 244a-1 of FIG. 2A), with the understanding that an aggregate schedule may be generated for any and all terminals that may be served by network/system infrastructure.

In a particular example, it may be assumed that during slot 0 shown in FIG. 2B that the control channel (C0) has the associated parameter k0 set equal to 0—e.g., an instance of same slot scheduling. In this respect, the terminal may obtain the data/traffic as part of slot 0 in conjunction with the data channel D0. Thereafter, it may be the case that during slot 1 the control channel C1 indicates a parameter value for k0=19, thus representing an offset of nineteen from the current slot (slot 1), landing into slot 20 as shown. It may be the case that, up to the point of time coinciding with slot 1, that the scheduler anticipates an opportunity for the terminal to enter extended sleep or power saving mode of operations. For example, at the time that the data is obtained by the scheduler, it may be the case that the scheduler does not foresee any additional data transfer operations involving the terminal for an extended period of time, and that the data that has been obtained for the terminal (subsequent to slot 0) is not considered to be critical (e.g., is indicative of non-critical payload-data traffic). Thereafter, at a time coinciding with slot 17, it may be the case that the control channel C17 indicates that high priority data/traffic (e.g., C2 traffic) needs to be transferred as part of an operation involving the terminal.

Depending on the nature of the high priority data/traffic, it may be possible to piggy-back the high priority data/traffic as part of the transfer operations scheduled to occur as part of slot 20. For example, if both the original data that was reallocated from slot 1 to slot 20 and the newly-obtained high priority data/traffic (of slot 17) can both be transferred during slot 20 (due to sufficient capacity in terms of available bandwidth, for example), then the high priority data/traffic may be assigned a value of k0=3 to push the high priority data/traffic from slot 17 to slot 20.

Continuing the above example, if the original data that was reallocated from slot 1 to slot 20 and the newly-obtained high priority data/traffic (of slot 17) cannot both be transferred during slot 20 (due to a bandwidth limitation or constraint, for example), the newly-obtained high-priority traffic (of slot 17) might be a candidate for transfer during slot 19 (e.g., just before slot 20) with a value of k0=2, or during slot 21 (e.g., just after slot 20) with a value of k0=4. In either case, assurances may be provided that the selected slot will meet QoS requirements for the high priority data/traffic, while at the same time attempting to promote power savings by transferring all data/traffic involving the terminal in consecutive/adjacent timeslots. The parameter L, corresponding to the allocation length as described above, may be adjusted by the scheduler to account for the consumption of multiple slots.

If, in the example above, it is not possible to transfer the newly-obtained high priority traffic as part of any of slots 19, 20, or 21, then the scheduler may opt to take a different action. For example, it might be necessary to: schedule the newly-obtained high priority traffic earlier (such as for example as part of slot 17 [k0=0] or slot 18 [k0=1]), to further bump or pushout the original data that was reallocated from slot 1 to slot 20 in time (such as for example in relation to slot 25—not shown in FIG. 2B) to make room for the newly-obtained high priority traffic as part of slot 20 (for example), or take some other action.

What the foregoing examples demonstrate is that aspects of this disclosure may enable an intelligent scheduler (which may be included as part of network/system infrastructure in some embodiments, and which may be implemented in conjunction with an application in some embodiments) to pick-and-choose when to schedule data transfer operations involving a terminal. Furthermore, it is understood that the scheduler may be comprehensive in nature in the sense that the scheduler may schedule data transfer operations involving a plurality of terminals as referenced above. Once a relative priority is established amongst different types or classes of data or traffic, the scheduler can select resources (e.g., timeslots) to facilitate the conveyance of the traffic/data to meet QoS, QoE, or KPI requirements, while at the same time affording a terminal an opportunity to enter a power-saving or sleep mode of operations, thereby helping to conserve battery-power and reduce power dissipation at/by the terminal.

In some embodiments, artificial intelligence (AI) and/or machine learning (ML) may be utilized to determine/identify/select an appropriate value of k0 to use in respect of a given item of data or traffic, to appropriately balance or tradeoff quality in performance on the one hand and resource preservation on the other hand. In general, C2 traffic may take on a higher priority or precedence relative to payload-data traffic. Accordingly, and all other conditions being assumed equal, it may be desirable to schedule C2 traffic with a relatively small value of k0 (so as to not delay the transfer of the C2 traffic), whereas payload-data traffic may be assigned/allocated a large value of k0 (so as to afford a terminal opportunities to enter power-saving or sleep mode of operations). Of course, an upper-limit may exist as to the value of k0 in respect of payload-data traffic to ensure that payload-data is timely provided to (in the downlink direction), or received from (in the uplink direction), the terminal.

In some embodiments, terminals may be distinguished from one another based on a use of terminal identifier, an address, or the like. If two terminal are competing for access to resources, preference may be given/awarded to a first terminal that is determined to be providing a higher priority service or executing a higher prior application relative to a second terminal. To demonstrate, a first drone supporting emergency/first responder communication services may be given priority of access to communication resources relative to a second drone supporting commercial communication services.

Referring now to FIG. 2C, an illustrative embodiment of a method 200c in accordance with various aspects described herein is shown. The method 200c may be implemented or executed, in whole or in part, in conjunction with one or more systems, devices, and/or components, such as for example the systems, devices, and components set forth herein. In some embodiments, the method 200c may be wholly or partially implemented or executed via one or more processing systems, where each such processing system may include one or more processors. Further, in some embodiments, operations of the method 200c may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200c are described below in relation to the blocks shown in FIG. 2C. In some embodiments, one or more blocks or operations may be based on one or more other blocks or operations. Aspects of the method 200c may be used to facilitate a scheduling of data transfer operations involving one or more terminals.

In block 204c, data may be obtained. For example, in the context of supporting a terminal (e.g., a UAV or drone), the data may include or pertain to first data corresponding to control data (that may control operations of the terminal) and second data corresponding to payload-data (that may be associated with an application executed or supported by the terminal).

In block 208c, a transfer/transmission of the data to the terminal may be scheduled. The scheduling of block 208c may take place in accordance with priority values or levels that may be assigned to the data (e.g., to the first data and the second data). For example, it may be the case that the first data is of a higher importance or priority relative to the second data, and so, all other things being equal, the scheduling of block 208c may attempt to convey the first data earlier than the second data and/or convey the first data and/or the second data as soon as possible, while still taking into account/consideration resource availability and resource preservation goals/objectives. To demonstrate, and as described elsewhere herein, aspects of the block 208c may attempt to convey as much data as possible in a given timeslot to a terminal, or make use of consecutive/adjacent timeslots to the extent possible, to enable the terminal to enter a power-saving or sleep mode of operations whereby the terminal can at least partially power-down/power-off a receiver, a transmitter, or associated storage/buffer elements/components.

In block 212c, the data (of block 204c) may be transferred/transmitted to the terminal in accordance with the scheduling of block 208c. In some embodiments, one or more physical or logical channels may be utilized as part of block 212c.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Aspects of this disclosure may provide a service-aware dual cross-slot scheduling mechanism for terminals (e.g., aerial drones) as part of a network or system to achieve power savings while respecting/maintaining QoS, QoE, and KPI based requirements. In some embodiments, a centralized self-learning network configuration may be obtained for enhancing (e.g., optimizing) terminal power savings, which can be used as part of a cascade in respect of a cluster of elements or terminals. As part of this disclosure, new or modified Information Elements (IEs) may be introduced as part of one or more standards, protocols, specifications, or the like, such as those promulgated by the 3GPP, to facilitate a cross-slot scheduling object for multi-mode/multi-class (e.g., dual-mode/dual-class) types of traffic. It is understood and appreciated that aspects of this disclosure may be applied in respect of many types of communication networks and systems, such as commercial networks/systems, government-run networks/systems, and the like.

As set forth herein, aspects of this disclosure may be utilized as part of practical applications to intelligently and efficiently schedule/manage resources as part of provisioning data/traffic in respect of one or more terminals. For example, autonomous vehicles, such as UAVs, connected vehicles, and the like, may use various technologies (e.g., LTE, 5G, etc.) to communicate with a central ground station (e.g., a base station). A C2 link (or more generally, a first link) may be responsible for delivering management, navigation, and control traffic to a terminal, whereas a payload-data link (or more generally, a second link) may be responsible for delivering payload-data traffic to the terminal. Of course, similar considerations may be applied in respect of data or traffic from the terminal to the ground station (in, e.g., the uplink direction).

As demonstrated above, aspects of this disclosure are directed to substantial improvements to technology as those improvements relate to practical applications dealing with management and use of a fleet of elements (e.g., a fleet of terminals). Aspects of this disclosure may be used to strike an appropriate balance between timeliness of data transfer operations on the one hand, and preserving resources (e.g., communication bandwidth, battery power, etc.) on the other hand. By differentiating amongst various types of data flows or traffic, an appropriate treatment to such data flows or traffic may be provided/realized. As one skilled in the art will appreciate based on a review of this disclosure, the various aspects of this disclosure are not directed to abstract ideas. To the contrary, the various aspects of this disclosure are directed to, and encompass, significantly more than any abstract idea standing alone. Indeed, the various aspects of this disclosure facilitate a generation of useful, concrete, tangible and transformative results.

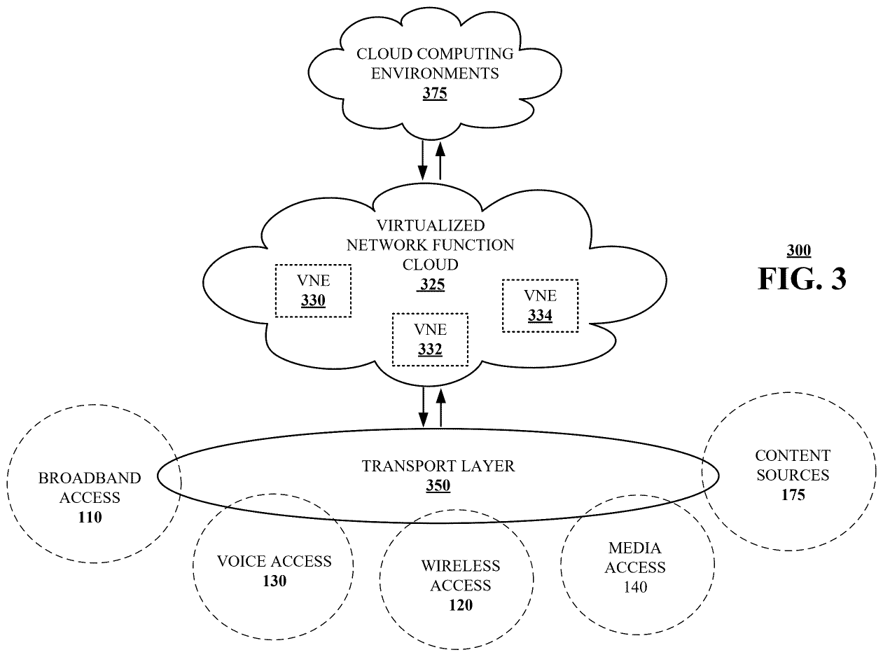

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200a, and method 200c presented in FIGS. 1, 2A, and 2C. For example, the virtualized communication network 300 can facilitate, in whole or in part, obtaining first data and second data, wherein the first data is classified as having a first priority value and the second data is classified as having a second priority value that is different from the first priority value, scheduling a transfer of the first data to a terminal in accordance with the first priority value such that the transfer of the first data occurs during a first timeslot included in a plurality of timeslots, and scheduling a transfer of the second data to the terminal in accordance with the second priority value such that the transfer of the second data occurs during a second timeslot included in the plurality of timeslots. The virtualized communication network 300 can facilitate, in whole or in part, obtaining first data associated with a first drone, the first data including first control data that controls a first maneuver of the first drone, obtaining second data associated with the first drone, the second data including first payload data associated with a first application executed by the first drone, scheduling a transfer of the first data and the second data to the first drone based on a first priority level associated with the first control data and a second priority level associated with the first payload data, wherein the scheduling provides that the first drone enters a first power-saving mode of operation upon a completion of the transfer of the first data and the second data to the first drone, and transferring the first data and the second data to the first drone based on the scheduling of the transfer of the first data and the second data to the first drone. The virtualized communication network 300 can facilitate, in whole or in part, transmitting, by a processing system including a processor, a downlink control information (DCI) element to a terminal during a first timeslot, wherein the DCI element includes a value of an offset parameter corresponding to a difference in timeslots from the first timeslot to a second timeslot that is subsequent to the first timeslot, transmitting, by the processing system and based on the transmitting of the DCI element to the terminal, control data to the terminal during the second timeslot, the control data controlling an operation of the terminal, and transmitting, by the processing system and based on the transmitting of the DCI element to the terminal, payload data to the terminal during one of the second timeslot or a third timeslot.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

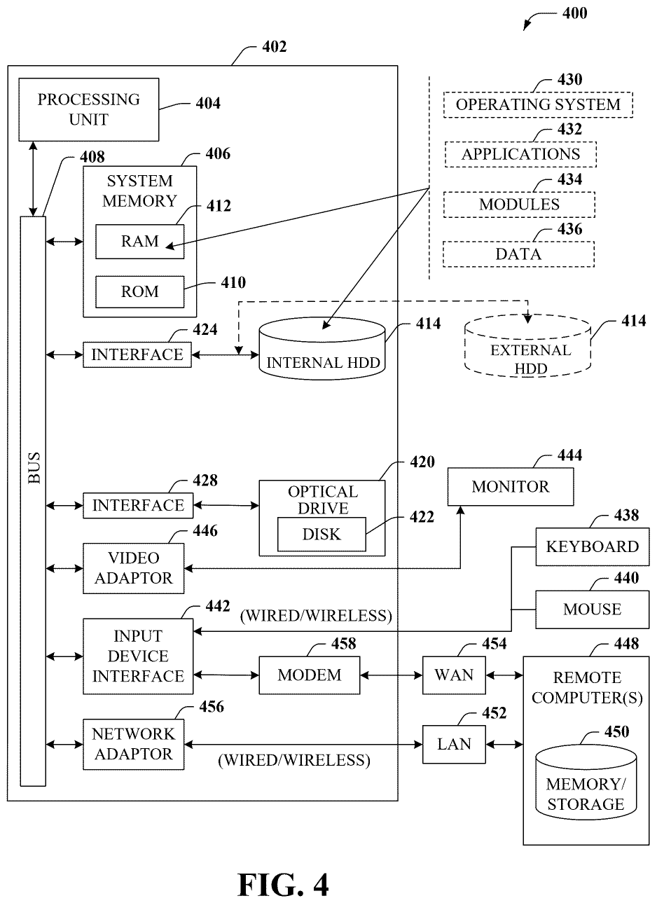

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, the computing environment 400 can facilitate, in whole or in part, obtaining first data and second data, wherein the first data is classified as having a first priority value and the second data is classified as having a second priority value that is different from the first priority value, scheduling a transfer of the first data to a terminal in accordance with the first priority value such that the transfer of the first data occurs during a first timeslot included in a plurality of timeslots, and scheduling a transfer of the second data to the terminal in accordance with the second priority value such that the transfer of the second data occurs during a second timeslot included in the plurality of timeslots. The computing environment 400 can facilitate, in whole or in part, obtaining first data associated with a first drone, the first data including first control data that controls a first maneuver of the first drone, obtaining second data associated with the first drone, the second data including first payload data associated with a first application executed by the first drone, scheduling a transfer of the first data and the second data to the first drone based on a first priority level associated with the first control data and a second priority level associated with the first payload data, wherein the scheduling provides that the first drone enters a first power-saving mode of operation upon a completion of the transfer of the first data and the second data to the first drone, and transferring the first data and the second data to the first drone based on the scheduling of the transfer of the first data and the second data to the first drone. The computing environment 400 can facilitate, in whole or in part, transmitting, by a processing system including a processor, a downlink control information (DCI) element to a terminal during a first timeslot, wherein the DCI element includes a value of an offset parameter corresponding to a difference in timeslots from the first timeslot to a second timeslot that is subsequent to the first timeslot, transmitting, by the processing system and based on the transmitting of the DCI element to the terminal, control data to the terminal during the second timeslot, the control data controlling an operation of the terminal, and transmitting, by the processing system and based on the transmitting of the DCI element to the terminal, payload data to the terminal during one of the second timeslot or a third timeslot.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), and an optical disk drive 420, (e.g., reading a CD-ROM disk 422 or, to read from or write to other high-capacity optical media such as the DVD). The HDD 414 and optical disk drive 420 can be connected to the system bus 408 by a hard disk drive interface 424, and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

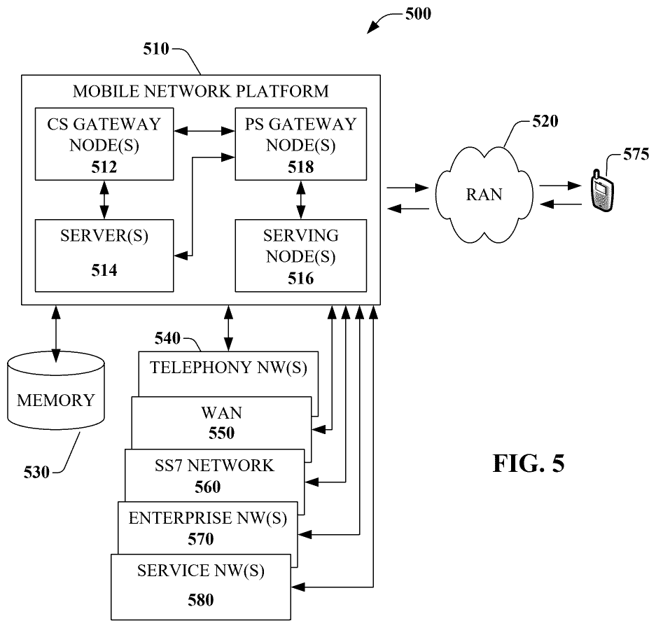

Turning now to FIG. 5, an embodiment 500 of a mobile network platform 510 is shown that is an example of network elements 150, 152, 154, 156, and/or VNEs 330, 332, 334, etc. For example, the platform 510 can facilitate, in whole or in part, obtaining first data and second data, wherein the first data is classified as having a first priority value and the second data is classified as having a second priority value that is different from the first priority value, scheduling a transfer of the first data to a terminal in accordance with the first priority value such that the transfer of the first data occurs during a first timeslot included in a plurality of timeslots, and scheduling a transfer of the second data to the terminal in accordance with the second priority value such that the transfer of the second data occurs during a second timeslot included in the plurality of timeslots. The platform 510 can facilitate, in whole or in part, obtaining first data associated with a first drone, the first data including first control data that controls a first maneuver of the first drone, obtaining second data associated with the first drone, the second data including first payload data associated with a first application executed by the first drone, scheduling a transfer of the first data and the second data to the first drone based on a first priority level associated with the first control data and a second priority level associated with the first payload data, wherein the scheduling provides that the first drone enters a first power-saving mode of operation upon a completion of the transfer of the first data and the second data to the first drone, and transferring the first data and the second data to the first drone based on the scheduling of the transfer of the first data and the second data to the first drone. The platform 510 can facilitate, in whole or in part, transmitting, by a processing system including a processor, a downlink control information (DCI) element to a terminal during a first timeslot, wherein the DCI element includes a value of an offset parameter corresponding to a difference in timeslots from the first timeslot to a second timeslot that is subsequent to the first timeslot, transmitting, by the processing system and based on the transmitting of the DCI element to the terminal, control data to the terminal during the second timeslot, the control data controlling an operation of the terminal, and transmitting, by the processing system and based on the transmitting of the DCI element to the terminal, payload data to the terminal during one of the second timeslot or a third timeslot.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

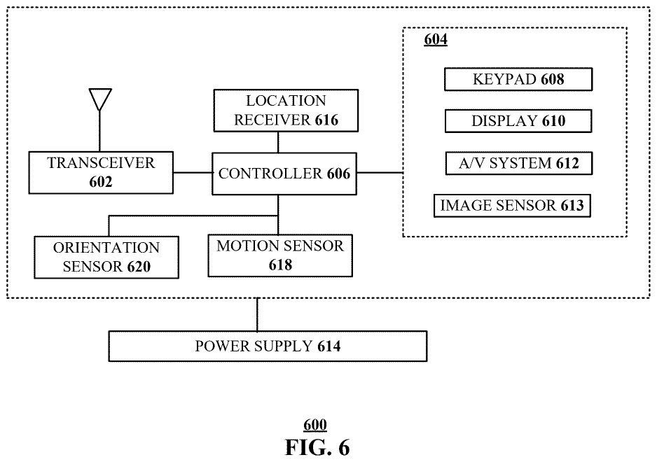

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, the computing device 600 can facilitate, in whole or in part, obtaining first data and second data, wherein the first data is classified as having a first priority value and the second data is classified as having a second priority value that is different from the first priority value, scheduling a transfer of the first data to a terminal in accordance with the first priority value such that the transfer of the first data occurs during a first timeslot included in a plurality of timeslots, and scheduling a transfer of the second data to the terminal in accordance with the second priority value such that the transfer of the second data occurs during a second timeslot included in the plurality of timeslots. The computing device 600 can facilitate, in whole or in part, obtaining first data associated with a first drone, the first data including first control data that controls a first maneuver of the first drone, obtaining second data associated with the first drone, the second data including first payload data associated with a first application executed by the first drone, scheduling a transfer of the first data and the second data to the first drone based on a first priority level associated with the first control data and a second priority level associated with the first payload data, wherein the scheduling provides that the first drone enters a first power-saving mode of operation upon a completion of the transfer of the first data and the second data to the first drone, and transferring the first data and the second data to the first drone based on the scheduling of the transfer of the first data and the second data to the first drone. The computing device 600 can facilitate, in whole or in part, transmitting, by a processing system including a processor, a downlink control information (DCI) element to a terminal during a first timeslot, wherein the DCI element includes a value of an offset parameter corresponding to a difference in timeslots from the first timeslot to a second timeslot that is subsequent to the first timeslot, transmitting, by the processing system and based on the transmitting of the DCI element to the terminal, control data to the terminal during the second timeslot, the control data controlling an operation of the terminal, and transmitting, by the processing system and based on the transmitting of the DCI element to the terminal, payload data to the terminal during one of the second timeslot or a third timeslot.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining first data and second data, wherein the first data is classified as having a first priority value and the second data is classified as having a second priority value that is different from the first priority value;
scheduling a transfer of the first data to a terminal in accordance with the first priority value such that the transfer of the first data occurs during a first timeslot included in a plurality of timeslots; and
scheduling a transfer of the second data to the terminal in accordance with the second priority value such that the transfer of the second data occurs during a second timeslot included in the plurality of timeslots.

2. The device of claim 1, wherein the terminal includes an unmanned aerial vehicle.

3. The device of claim 1, wherein the first priority value and the second priority value are such that the first data has a higher priority relative to the second data.

4. The device of claim 3, wherein the first data includes control data that controls operations of the terminal, and wherein the second data includes payload-data associated with an application executed by the terminal.

5. The device of claim 3, wherein the device is included as part of a ground station, and wherein the operations further comprise:
transmitting data channels and control channels to the terminal in a second plurality of timeslots, and wherein the data channels and the control channels are delivered in different timeslots of the second plurality of timeslots.

6. The device of claim 3, wherein the terminal decodes a control channel timeslot included in the plurality of timeslots and reads a downlink control information (DCI) element that provides an offset parameter corresponding to a number of an upcoming timeslot where third data is scheduled for the terminal in a corresponding data channel, such that the terminal enters a power-saving mode for a time duration that correlates to the offset parameter.

7. The device of claim 3, wherein a third timeslot of the plurality of timeslots in which a first offset parameter associated with the first data occurs before a fourth timeslot of the plurality of timeslots in which a second offset parameter associated with the second data occurs, and wherein the first offset parameter is different from the second offset parameter.

8. The device of claim 7, wherein due to a misalignment in timeslots as between the third timeslot and the fourth timeslot and the first and second offset parameters the terminal is not able to enter a power-saving mode for greater than a threshold amount of time.

9. The device of claim 3, wherein the operations further comprise:
adjusting, based on an analysis of the first priority value and the second priority value, a first offset to align the transfer of the first data and second data to the terminal in a same data channel to enhance terminal power-saving while satisfying traffic requirements of the first data and the second data.

10. The device of claim 3, wherein the operations further comprise:
maintaining, based on an analysis of the first priority value and the second priority value, a first offset to cause the transfer of the first data to occur in a first data channel and the transfer of the second data to occur in a second data channel that is different from the first data channel to satisfy traffic requirements of the first data and the second data.

11. The device of claim 3, wherein the second timeslot and the first timeslot are a same timeslot.

12. The device of claim 3, wherein the second timeslot and the first timeslot are different timeslots, and wherein the second timeslot and the first timeslot are adjacent timeslots included in the plurality of timeslots.

13. The device of claim 12, wherein the first timeslot is prior to the second timeslot.

14. The device of claim 12, wherein the first timeslot is subsequent to the second timeslot.

15. The device of claim 12, wherein subsequent to the transfer of the first data and the transfer of the second data the terminal enters a power-saving mode of operation, wherein in the power-saving mode of operation the terminal decodes a control channel associated with a timeslot included in the plurality of timeslots, and wherein in the power-saving mode of operation the terminal does not buffer data conveyed over a data channel associated with the timeslot included in the plurality of timeslots.

16. The device of claim 1, wherein the scheduling of the transfer of the first data to the terminal in accordance with the first priority value is based on a use of a first value for an offset parameter, wherein the scheduling of the transfer of the second data to the terminal in accordance with the second priority value is based on a use of a second value for the offset parameter, and wherein the second value for the offset parameter is different from the first value for the offset parameter.

17. A non-transitory machine-readable medium, comprising executable instructions that, when executed by a processing system including a processor, facilitate performance of operations, the operations comprising:
obtaining first data associated with a first drone, the first data including first control data that controls a first maneuver of the first drone;
obtaining second data associated with the first drone, the second data including first payload data associated with a first application executed by the first drone;
scheduling a transfer of the first data and the second data to the first drone based on a first priority level associated with the first control data and a second priority level associated with the first payload data, wherein the scheduling provides that the first drone enters a first power-saving mode of operation upon a completion of the transfer of the first data and the second data to the first drone; and
transferring the first data and the second data to the first drone based on the scheduling of the transfer of the first data and the second data to the first drone.

18. The non-transitory machine-readable medium of claim 17, wherein the first maneuver includes a change to: a direction of travel of the first drone, an altitude of the first drone, a speed of the first drone, an acceleration of the first drone, or any combination thereof, wherein the first payload data includes: a map, a video, an image, or any combination thereof, and wherein the operations further comprise:
obtaining third data associated with a second drone, the third data including second control data that controls a second maneuver of the second drone;
obtaining fourth data associated with the second drone, the fourth data including second payload data associated with a second application executed by the second drone;
scheduling a transfer of the third data and the fourth data to the second drone based on a third priority level associated with the second control data, a fourth priority level associated with the second payload data, and the scheduling of the transfer of the first data and the second data to the first drone, wherein the scheduling of the transfer of the third data and the fourth data provides that the second drone enters a second power-saving mode of operation upon a completion of the transfer of the third data and the fourth data to the second drone; and
transferring the third data and the fourth data to the second drone based on the scheduling of the transfer of the third data and the fourth data to the second drone.

19. A method, comprising:
transmitting, by a processing system including a processor, a downlink control information (DCI) element to a terminal during a first timeslot, wherein the DCI element includes a value of an offset parameter corresponding to a difference in timeslots from the first timeslot to a second timeslot that is subsequent to the first timeslot;
transmitting, by the processing system and based on the transmitting of the DCI element to the terminal, control data to the terminal during the second timeslot, the control data controlling an operation of the terminal; and
transmitting, by the processing system and based on the transmitting of the DCI element to the terminal, payload data to the terminal during one of the second timeslot or a third timeslot.

20. The method of claim 19, wherein the transmitting of the payload data occurs during the third timeslot, and wherein the third timeslot is adjacent to the second timeslot, the method further comprising:
transmitting, by the processing system, second control data to the terminal, such that the terminal controls data transfer operations involving a second terminal, wherein the terminal and the second terminal are arranged in a cascade relationship relative to the processing system.
